(19) United States
(12) Patent Application Publication
(10) Pub. No.: US 2022/0082791 A1
(43) Pub. Date: Mar. 17, 2022

(54) Lens Assembly

(71) Applicants: Sintai Optical (Shenzhen) Co., Ltd., ShenZhen City (CN); Asia Optical Co., Inc., Taichung (TW)

(72) Inventors: Jia-Sin CHEN, Taichung (TW); Po-Yu CHEN, Taichung (TW)

(21) Appl. No.: 17/412,318

(22) Filed: Aug. 26, 2021

(30) Foreign Application Priority Data
Sep. 14, 2020 (CN) 202010962796.4

(51) Int. Cl. G02B 9/62; G02B 13/18

(52) U.S. Cl. CPC G02B 9/62; G02B 13/18

(57) ABSTRACT

A lens assembly includes a first lens, a second lens, a third lens, a fourth lens, a fifth lens, and a sixth lens. The first lens has negative refractive power and includes a concave surface facing an image side. The second lens has positive refractive power and includes a convex surface facing an object side. The third lens has positive refractive power. The fourth lens has negative refractive power. The fifth lens is a meniscus lens with positive refractive power. The sixth lens has positive refractive power and includes a concave surface facing the image side. The first lens, the second lens, the third lens, the fourth lens, the fifth lens, and the sixth lens are arranged in order from the object side to the image side along an optical axis. An air gap is between the third lens and the fourth lens.

### BACKGROUND OF THE INVENTION

### Field of the Invention

The present disclosure relates to a lens assembly.

### Description of the Related Art

The development of lens assembly nowadays is tending toward having a large aperture. Additionally, the lens assembly is developed to have high resolution and resistance to environmental temperature change in accordance with different application requirements. However, the known lens assembly can't satisfy such requirements. Therefore, the lens assembly needs a new structure in order to meet the requirements of large aperture, high resolution, and resistance to environmental temperature change at the same time.

### BRIEF SUMMARY OF THE INVENTION

The invention provides a lens assembly to solve the above problems. The lens assembly of the invention is provided with characteristics of a decreased F-number, an increased resolution, a resisted environmental temperature change, and still has a good optical performance.

According to an embodiment, the present disclosure provides a lens assembly including a first lens, a second lens, a third lens, a fourth lens, a fifth lens and a sixth lens. The first lens has negative refractive power and includes a concave surface facing an image side. The second lens has positive refractive power and includes a convex surface facing an object side. The third lens has positive refractive power. The fourth lens has negative refractive power. The fifth lens is a meniscus lens with positive refractive power. The sixth lens has positive refractive power and includes a concave surface facing the image side. The first to sixth lenses are arranged in order from the object side to the image side along an optical axis. An air gap is between the third lens and the fourth lens.

According to another embodiment, the present disclosure provides a lens assembly including a first lens, a second lens, a third lens, a fourth lens, a fifth lens and a sixth lens. The first lens has negative refractive power and includes a concave surface facing an image side. The second lens has positive refractive power and includes a convex surface facing an object side. The third lens has positive refractive power. The fourth lens has negative refractive power. The fifth lens is a meniscus lens with positive refractive power. The sixth lens has positive refractive power and includes a concave surface facing the image side. The first to sixth lenses are arranged in order from the object side to the image side along an optical axis. The lens assembly satisfies: 6 mm<f₄+f₆<12 mm; wherein f₄ is a focal length in mm of the fourth lens and f₆ is a focal length in mm of the sixth lens.

In one of the above embodiments, the third lens includes a convex surface facing the object side and a convex surface facing the image side, the fourth lens includes a concave surface facing the object side and a concave surface facing the image side.

In one of the above embodiments, the lens assembly further includes a stop disposed between the third lens and the fourth lens.

In one of the above embodiments, the first lens, the second lens or the third lens includes at least one spherical glass lens.

In one of the above embodiments, the lens assembly satisfies: 120<Vd1+Vd3<140; wherein Vd₁ is an Abbe number of the first lens and Vd₃ is an Abbe number of the third lens.

In one of the above embodiments, the first lens further includes a concave surface facing the object side, the second lens further includes a convex surface facing the image side.

In one of the above embodiments, the lens assembly satisfies: −7<R₂₂/R₂₁48; wherein R₂₁ is the radius of curvature of the object side surface of the first lens and R₂₂ is the radius of curvature of the image side surface of the second lens.

In one of the above embodiments, the fifth lens comprises a concave surface facing the object side and a convex surface facing the image side, the sixth lens further comprises a convex surface facing the object side.

In one of the above embodiments, the first lens further includes a convex surface facing the object side, the second lens further includes a concave surface facing the image side.

In one of the above embodiments, the fourth lens, the fifth lens or the sixth lens includes at least one spherical glass lens.

In one of the above embodiments, the lens assembly satisfies: 3.9<TTL/BFL<6; wherein TTL is an interval from an object side surface of the first lens to the image plane along the optical axis and BFL is an interval from an image side surface of the sixth lens to an image plane along the optical axis.

In one of the above embodiments, the lens assembly satisfies: 0.4<(f₃±f₄)/f<0.62; wherein f₃ is an effective focal length of the third lens, f₄ is an effective focal length of the fourth lens, and f is the effective focal length of the lens assembly.

In one of the above embodiments, the lens assembly satisfies: 6 mm<f₄+f₆<12 mm; wherein f₄ is an effective focal length of the fourth lens, f₆ is an effective focal length in mm of the sixth lens.

In one of the above embodiments, the lens assembly satisfies: 0.05<f₁₂₃/f₄₅₆<0.22; wherein f₁₂₃ is an effective focal length of a combination of the first lens, the second lens and the third lens, and f₄₅₆ is an effective focal length of a combination of the fourth lens, the fifth lens and the sixth lens.

The above objects, features and advantages of the present disclosure will be more clearly understood from the following detailed description taken in conjunction with exemplary embodiments and the accompanying drawings.

### BRIEF DESCRIPTION OF THE DRAWINGS

FIG. 1 is a lens layout and optical path diagram of a lens assembly in accordance with a first embodiment of the present disclosure.

FIG. 2A is a schematic diagram illustrating the field curvature of the lens assembly according to the first embodiment of the present disclosure.

FIG. 2B is a schematic diagram illustrating the distortion of the lens assembly according to the first embodiment of the present disclosure.

FIG. 2C is a schematic diagram illustrating the modulation transfer function of the lens assembly according to the first embodiment of the present disclosure.

FIG. 3 is a lens layout and optical path diagram of a lens assembly in accordance with a second embodiment of the present disclosure.

FIG. 4A is a schematic diagram illustrating the field curvature of the lens assembly according to the second embodiment of the present disclosure.

FIG. 4B is a schematic diagram illustrating the distortion of the lens assembly according to the second embodiment of the present disclosure.

FIG. 4C is a schematic diagram illustrating the modulation transfer function of the lens assembly according to the second embodiment of the present disclosure.

FIG. 5 is a lens layout and optical path diagram of a lens assembly in accordance with a third embodiment of the present disclosure.

FIG. 6A is a schematic diagram illustrating the field curvature of the lens assembly according to the third embodiment of the present disclosure.

FIG. 6B is a schematic diagram illustrating the distortion of the lens assembly according to the third embodiment of the present disclosure.

FIG. 6C is a schematic diagram illustrating the modulation transfer function of the lens assembly according to the third embodiment of the present disclosure.

FIG. 7 is a lens layout and optical path diagram of a lens assembly in accordance with a fourth embodiment of the present disclosure.

FIG. 8A is a schematic diagram illustrating the longitudinal aberration of the lens assembly according to the fourth embodiment of the present disclosure.

FIG. 8B is a schematic diagram illustrating the field curvature of the lens assembly according to the fourth embodiment of the present disclosure.

FIG. 8C is a schematic diagram illustrating the distortion of the lens assembly according to the fourth embodiment of the present disclosure.

FIG. 8D is a schematic diagram illustrating the lateral color of the lens assembly according to the fourth embodiment of the present disclosure.

FIG. 8E is a schematic diagram illustrating the relative illumination of the lens assembly according to the fourth embodiment of the present disclosure.

FIG. 8F is a schematic diagram illustrating the modulation transfer function of the lens assembly according to the fourth embodiment of the present disclosure.

FIG. 8G is a schematic diagram illustrating the through focus modulation transfer function of the lens assembly according to the fourth embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, a fourth lens, a fifth lens and a sixth lens. The first lens has negative refractive power and includes a concave surface facing an image side. The second lens has positive refractive power and includes a convex surface facing an object side. The third lens has positive refractive power. The fourth lens has negative refractive power. The fifth lens is a meniscus lens with positive refractive power. The sixth lens has positive refractive power and includes a concave surface facing the image side. The first to sixth lenses are arranged in order from the object side to an image side along an optical axis. An air gap is between the third lens and the fourth lens.

In the aforesaid lens assembly, every two lens elements of the first lens element, the second lens element, the third lens element, the fourth lens element, the fifth lens element, and the sixth lens element have at least one air gap in between. Each of the first through the sixth lens elements is a single and non-cemented lens element. That is, any two lens elements adjacent to each other are not cemented, and there is a space between the two lens elements. Moreover, the manufacturing process of the cemented lenses is more complex than the non-cemented lenses. In particular, a second surface of one lens element and a first surface of the following lens element need to have an accurate curvature to ensure these two lens elements will be highly cemented. However, during the cementing process, those two lens elements might not be highly cemented due to displacement and it is thereby not favorable for the image quality of the imaging optical system. Therefore, the lens assembly of the present disclosure provides six non-cemented lens elements for improving the problem generated by the cemented lens elements.

Referring to Table 1, Table 3, Table 5, and Table 7, wherein Table 1, Table 3, Table 5, and Table 7 show optical specification in accordance with a first, second, third, and fourth embodiments of the invention respectively.

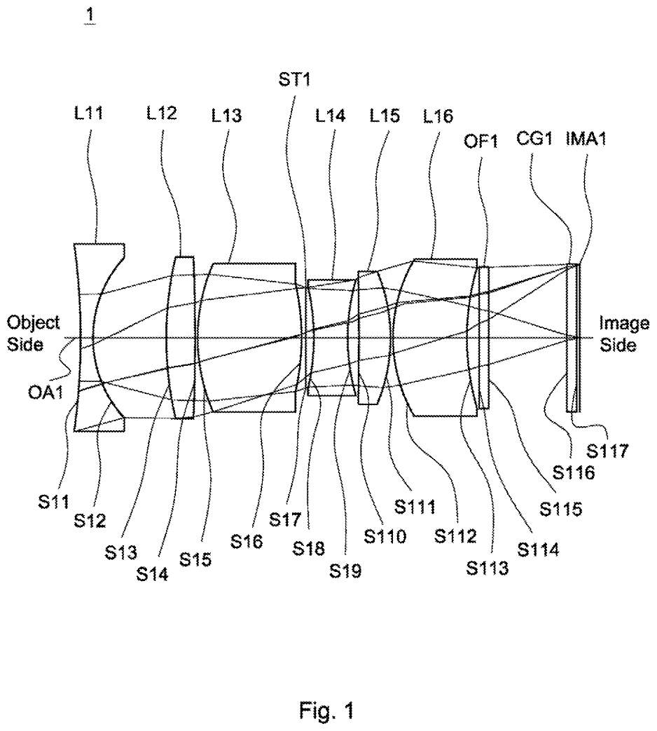

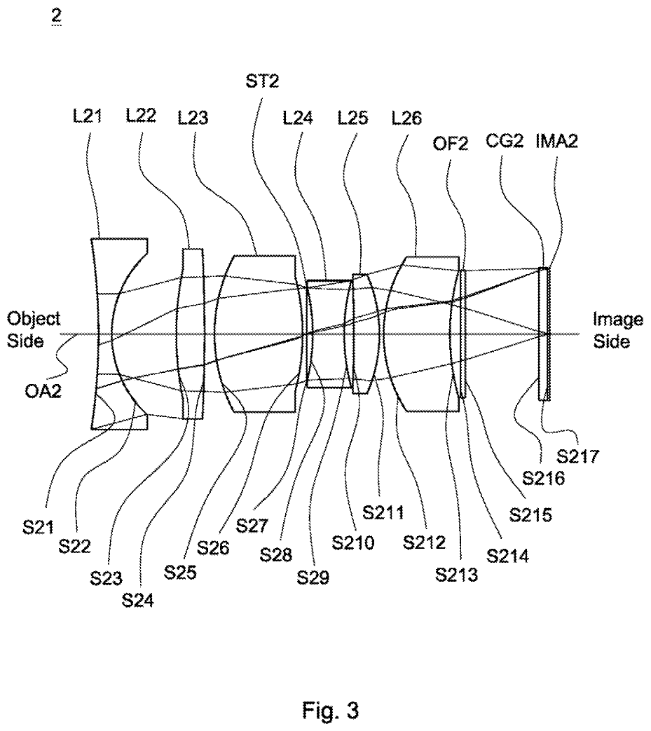

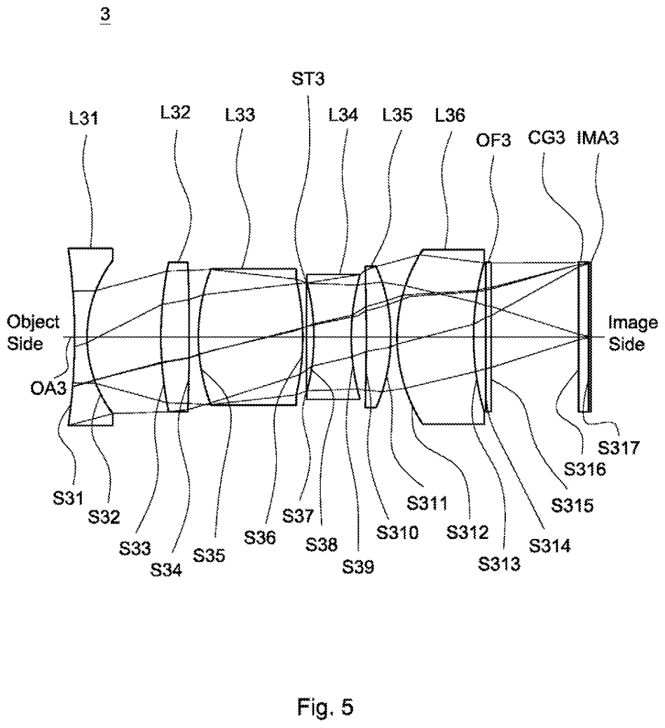

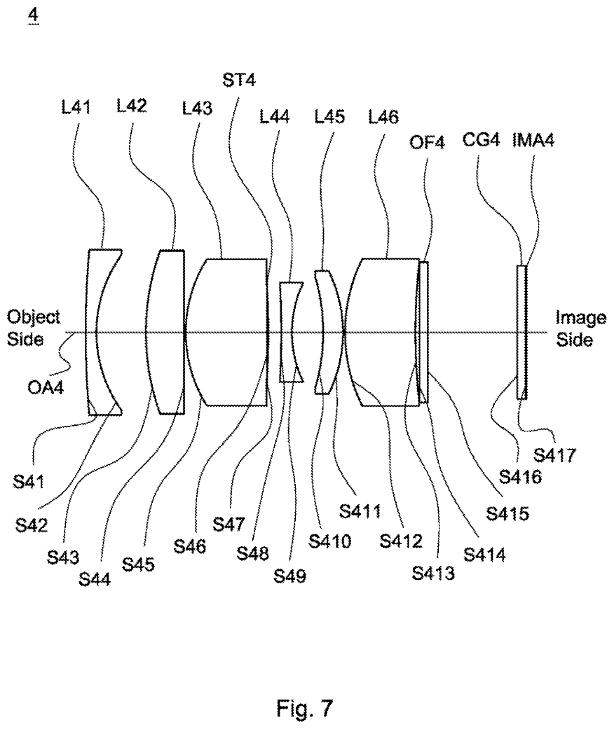

FIG. 1, FIG. 3, FIG. 5, and FIG. 7 are lens layout and optical path diagrams of the lens assembly in accordance with the first, second, third, and fourth embodiments of the invention respectively.

The first lens L11, L21, L31, L41 are with negative refractive power and made of glass material, wherein the image side surfaces S12, S22, S32, S42 are concave surfaces, and the object side surfaces S11, S21, S31, S41 and the image side surfaces S12, S22, S32, S42 are spherical surfaces.

The second lens L12, L22, L32, L42 are with positive refractive power and made of glass material, wherein the object side surfaces S13, S23, S33, S43 are convex surfaces, and the object side surfaces S13, S23, S33, S43 and the image side surfaces S14, S24, S34, S44 are spherical surfaces.

The third lens L13, L23, L33, L43 are biconvex lenses with positive refractive power and made of glass material, wherein the object side surfaces S15, S25, S35, S45 are convex surfaces, the image side surfaces S16, S26, S36, S46 are convex surfaces, and the object side surfaces S15, S25, S35, S45 and the image side surfaces S16, S26, S36, S46 are spherical surfaces.

The fourth lens L14, L24, L34, L44 are biconcave lenses with negative refractive power and made of glass material, wherein the object side surfaces S18, S28, S38, S48 are concave surfaces, the image side surfaces S19, S29, S39, S49 are concave surfaces, and the object side surfaces S18, S28, S38, S48 and the image side surfaces S19, S29, S39, S49 are spherical surfaces.

The fifth lens L15, L25, L35, L45 are meniscus lenses with positive refractive power and made of glass material, wherein the object side surfaces S110, S210, S310, S410 are concave surfaces, the image side surfaces S111, S211, S311, S411 are convex surfaces, and the object side surfaces S110, S210, S310, S410 and the image side surfaces S111, S211, S311, S411 are spherical surfaces.

The sixth lens L16, L26, L36, L46 are meniscus lenses with positive refractive power and made of glass material, wherein the object side surfaces S112, S212, S312, S412 are convex surfaces, the image side surfaces S113, S213, S313, S413 are concave surfaces, and the object side surfaces S112, S212, S312, S412 and the image side surfaces S113, S213, S313, S413 are spherical surfaces.

In addition, the lens assembly 1, 2, 3, 4 satisfy at least one of the following conditions:

120<Vd₁+Vd₃<140 (1)

0.4<(f₃+f₄)/f<0.62 (2)

−7<R₂₂/R₂₁<48 (3)

6 mm<f₄+f₆<12 mm (4)

3.9<TTL/BFL<6 (5)

0.05<f₁₂₃/f₄₅₆<0.22 (6)

Wherein Vd₁ is the Abbe number of the first lens L11, L21, L31, L41 for the first to fourth embodiments, Vd₃ is the Abbe number of the third lens L13, L23, L33, L43 for the first to fourth embodiments, f₃ is an effective focal length of the third lenses L13, L23, L33, L43 for the first to fourth embodiments, f₄ is an effective focal length of the fourth lenses L14, L24, L34, L44 for the first to fourth embodiments, f₆ is an effective focal length of the sixth lenses L16, L26, L36, L46 for the first to fourth embodiments, f is an effective focal length of the lens assemblies 1, 2, 3, 4 for the first to fourth embodiments, f₁₂₃ is the effective focal length of the combination of the first lens L11, L21, L31 L41, second lens L12, L22, L32, L42, and the third lens L13, L23, L33. L43 for the first to fourth embodiments, f₄₅₆ is the effective focal length of the combination of the fourth lens L14, L24, L34, L44, fifth lens L15, L25, L35, L45, and the sixth lens L16, L26, L36, L46 for the first to fourth embodiments, R₂₁ is the radius of curvature of an object-side surface S13, S23, S33, S43 of the first lens L12, L22, L32, L42 for the first to fourth embodiments, R₂₂ is the radius of curvature of an object-side surface S14, S24, S34, S44 of the first lens L12, L22, L32, L42 for the first to fourth embodiments, TTL is an interval in mm from the object side surfaces S11 S21, S31, S41 of the first lenses L11, L21, L31, L41 to the image planes IMA1, MA2, IMA3, IMA4 along the optical axes OA1, OA2, OA3, OA4 respectively for the first to fourth embodiments, and BFL is an interval in mm from the image side surfaces S113, S213, S313, 5413 of the sixth lenses L16, L26, L36, L46 to the image planes IMA1, IMA2, IMA3, IMA4 along the optical axes OA1, OA2, OA3, OA4 respectively for the first to fourth embodiments. With the lens assemblies 1, 2, 3, 4 satisfying at least one of the above conditions (1)-(6), the F-number can be effectively decreased, the resolution can be effectively increased, the environmental temperature change can be effectively resisted, the aberration can be effectively corrected, and the chromatic aberration can be effectively corrected.

When the condition (1): 120<Vd₁+Vd₃<140 is satisfied, the chromatic aberration can be better corrected to improve image quality.

When the condition (2): 0.4<(f₃+f₄)/f<0.62 is satisfied, the manufacturing sensitivity can be decreased to improve image quality.

When the condition (3): −7<R_{22/}R₂₁<48 is satisfied, the sensitivity of the second lens can be decreased to improve image quality.

When the condition (5): 3.9<TTL/BFL<6 is satisfied, the back focal length is longer, which is beneficial to the assembly and manufacturing of the lens assembly.

A detailed description of a lens assembly in accordance with a first embodiment of the invention is as follows. Referring to FIG. 1, the lens assembly 1 includes a first lens L11, a second lens L12, a third lens L13, a stop ST1, a fourth lens L14, a fifth lens L15, a sixth lens L16, an optical filter OF1, and a cover glass CG1, all of which are arranged in order from an object side to an image side along an optical axis OA1. In operation, an image of light rays from the object side is formed at an image plane IMA1.

According to paragraphs [0022]-[0031], wherein: the first lens L11 is a biconcave lens, wherein the object side surface S11 is a concave surface; the second lens L12 is a biconvex lens, wherein the image side surface S14 is a convex surface; both of the object side surface S114 and image side surface S115 of the optical filter OF1 are plane surfaces; and both of the object side surface S116 and image side surface S117 of the cover glass CG1 are plane surfaces.

With the above design of the lenses and stop ST1 and at least any one of the conditions (1)-(6) satisfied, the lens assembly 1 can have an effective decreased F-number, an effective increased resolution, an effective resisted environmental temperature change, an effective corrected aberration, and is capable of an effective corrected chromatic aberration.

Table 1 shows the optical specification of the lens assembly 1 in FIG. 1.

TABLE 1
Effective Focal Length = 6.04 mm
F-number = 1.64
Total Lens Length = 20.31 mm
Field of View = 58.01 degrees

| | Radius | | | | Effective | |
|---|---|---|---|---|---|---|
| | of Cur- | Thick- | | | Focal | |
| Surface | vature | ness | | | Length | |
| Number | (mm) | (mm) | Nd | Vd | (mm) | Remark |
| S11 | −27.61 | 0.50 | 1.52 | 64.21 | −7.93 | The First |
| | | | | | | Lens L11 |
| S12 | 4.86 | 2.99 | | | | |
| S13 | 14.60 | 1.17 | 2 | 25.46 | 12.31 | The Second |
| | | | | | | Lens L12 |
| S14 | −78.91 | 0.10 | | | | |
| S15 | 7.54 | 4.22 | 1.59 | 68.62 | 8.04 | The Third |
| | | | | | | Lens L13 |
| S16 | −10.32 | 0.18 | | | | |
| S17 | ∞ | 0.33 | | | | Stop ST1 |
| S18 | −9.34 | 1.38 | 1.96 | 17.47 | −4.41 | The Fourth |
| | | | | | | Lens L14 |
| S19 | 8.45 | 0.46 | | | | |
| S110 | −137.30 | 1.28 | 2 | 29.13 | 7.32 | The Fifth |
| | | | | | | Lens L15 |
| S111 | −7.03 | 0.10 | | | | |
| S112 | 6.32 | 3.01 | 1.77 | 49.6 | 15.85 | The Sixth |
| | | | | | | Lens L16 |
| S113 | 10.32 | 0.48 | | | | |
| S114 | ∞ | 0.40 | 1.52 | 54.52 | | Optical |
| | | | | | | Filter OF1 |
| S115 | ∞ | 3.21 | | | | |
| S116 | ∞ | 0.40 | 1.52 | 54.52 | | Cover |
| | | | | | | Glass CG1 |
| S117 | ∞ | 0.10 | | | | |

Table 2 shows the parameters and condition values for conditions (1)-(6) in accordance with the first embodiment of the invention. It can be seen from Table 2 that the lens assembly 1 of the first embodiment satisfies the conditions (1)-(6).

TABLE 2

| BFL | 4.59 mm | f₁₂₃ | 6.11 mm | f₄₅₆ | 30.22 mm |
|---|---|---|---|---|---|
| Vd₁ + Vd₃ | 132.83 | (f₃ + f₄)/f | 0.60 | R₂₂/R₂₁ | −5.40 |
| f₄ + f₆ | 11.44 | TTL/BFL | 4.42 | f₁₂₃/f₄₅₆ | 0.20 |

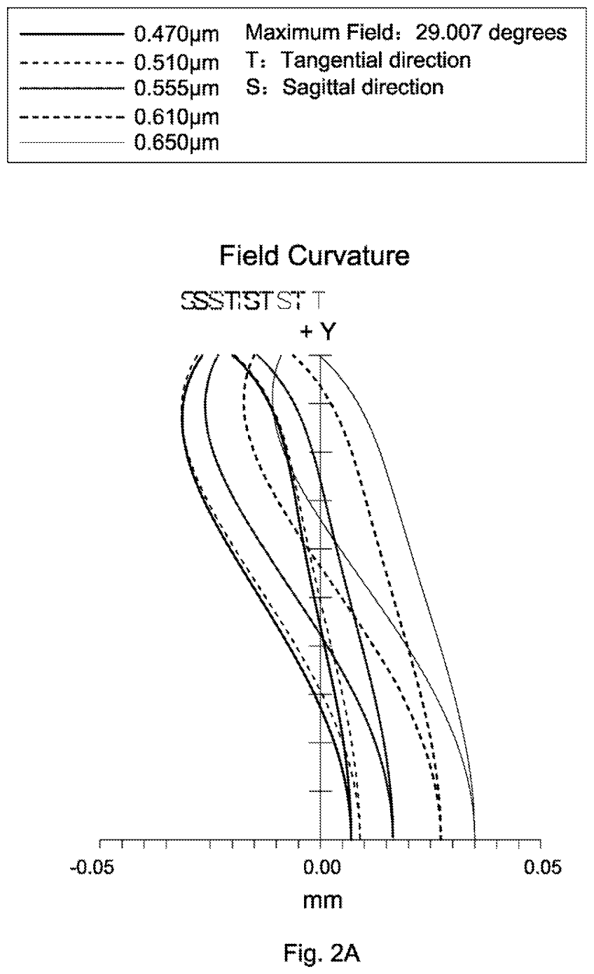

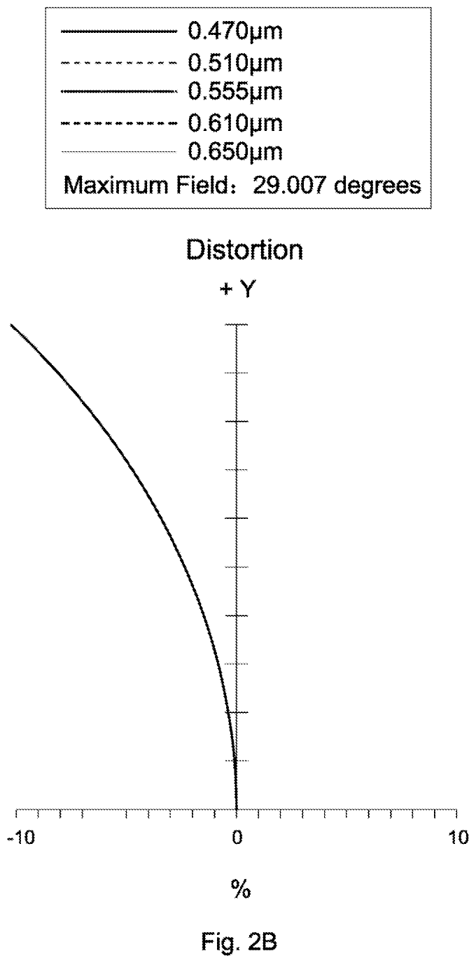

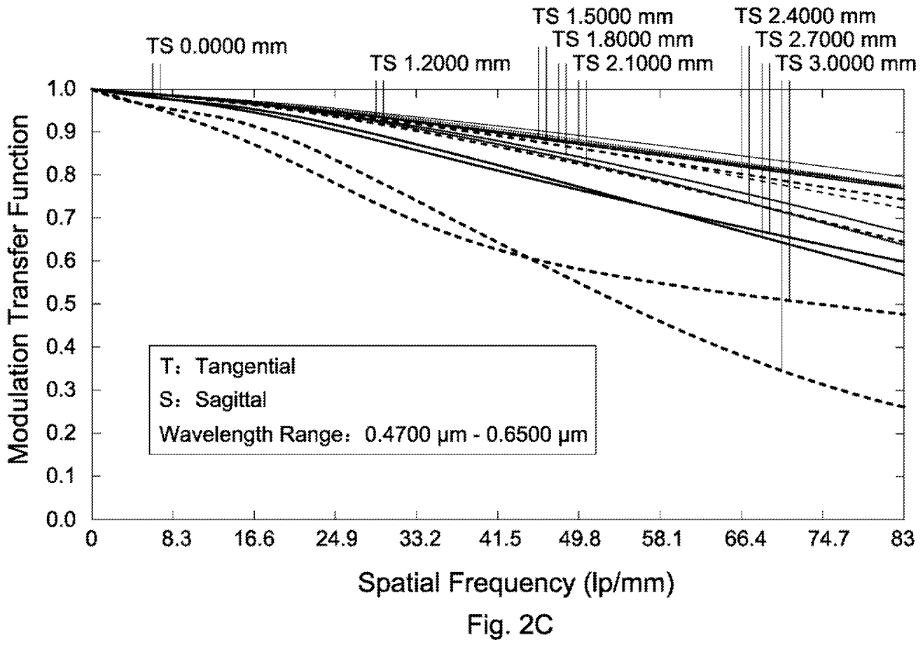

By the above arrangements of the lenses and stop ST1, the lens assembly 1 of the first embodiment can meet the requirements of optical performance as seen in FIGS. 2A-2C. It can be seen from FIG. 2A that the field curvature amount in the lens assembly 1 of the first embodiment ranges from −0.035 mm to 0.04 mm. It can be seen from FIG. 2B that the distortion in the lens assembly 1 of the first embodiment ranges from −10% to 0%. It can be seen from FIG. 2C that the modulation transfer function in the lens assembly 1 of the first embodiment ranges from 0.27 to 1.0.

It is obvious that the field curvature and the distortion of the lens assembly 1 of the first embodiment can be corrected effectively, and the resolution of the lens assembly of the first embodiment can meet the requirement. Therefore, the lens assembly 1 of the first embodiment is capable of good optical performance.

Referring to FIG. 3, FIG. 3 is a lens layout and optical path diagram of a lens assembly in accordance with a second embodiment of the invention. The lens assembly 2 includes a first lens L21, a second lens L22, a third lens L23, a stop ST2, a fourth lens L24, a fifth lens L25, a sixth lens L26, an optical filter OF2, and a cover glass CG2, all of which are arranged in order from an object side to an image side along an optical axis OA2. In operation, an image of light rays from the object side is formed at an image plane IMA2.

According to paragraphs [0022]-[0031], wherein: the first lens L21 is a biconcave lens, wherein the object side surface S21 is a concave surface; the second lens L22 is a biconvex lens, wherein the image side surface S24 is a convex surface; both of the object side surface S214 and image side surface S215 of the optical filter OF2 are plane surfaces; and both of the object side surface S216 and image side surface S217 of the cover glass CG2 are plane surfaces.

With the above design of the lenses and stop ST2 and at least any one of the conditions (1)-(6) satisfied, the lens assembly 2 can have an effective decreased F-number, an effective increased resolution, an effective resisted environmental temperature change, an effective corrected aberration, and is capable of an effective corrected chromatic aberration.

Table 3 shows the optical specification of the lens assembly 2 in FIG. 3.

TABLE 3
Effective Focal Length = 6.04 mm
F-number = 1.60
Total Lens Length = 20.51 mm
Field of View = 58.02 degrees

| | Radius | | | | Effective | |
|---|---|---|---|---|---|---|
| | of Cur- | Thick- | | | Focal | |
| Surface | vature | ness | | | Length | |
| Number | (mm) | (mm) | Nd | Vd | (mm) | Remark |
| S21 | −28.05 | 0.59 | 1.52 | 64.14 | −8.1 | The First |
| | | | | | | Lens L21 |
| S22 | 4.97 | 2.93 | | | | |
| S23 | 14.67 | 1.29 | 2 | 25.46 | 12.28 | The Second |
| | | | | | | Lens L22 |
| S24 | −75.70 | 0.45 | | | | |
| S25 | 7.57 | 4.00 | 1.59 | 60.99 | 8.03 | The Third |
| | | | | | | Lens L23 |
| S26 | −10.34 | 0.19 | | | | |
| S27 | ∞ | 0.27 | | | | Stop ST2 |
| S28 | −8.93 | 1.43 | 1.96 | 17.47 | −4.49 | The Fourth |
| | | | | | | Lens L24 |
| S29 | 9.13 | 0.44 | | | | |
| S210 | −63.35 | 1.16 | 2 | 29.14 | 7.46 | The Fifth |
| | | | | | | Lens L25 |
| S211 | −6.78 | 0.19 | | | | |
| S212 | 6.42 | 3.02 | 1.77 | 49.6 | 15.82 | The Sixth |
| | | | | | | Lens L26 |
| S213 | 10.71 | 0.48 | | | | |
| S214 | ∞ | 0.21 | 1.52 | 54.52 | | Optical |
| | | | | | | Filter OF2 |
| S215 | ∞ | 3.00 | | | | |
| S216 | ∞ | 0.40 | 1.52 | 54.52 | | Cover |
| | | | | | | Glass CG2 |
| S217 | ∞ | 0.44 | | | | |

Table 4 shows the parameters and condition values for conditions (1)-(6) in accordance with the second embodiment of the invention. It can be seen from Table 4 that the lens assembly 2 of the second embodiment satisfies the conditions (1)-(6).

TABLE 4

| BFL | 4.54 mm | f₁₂₃ | 6.09 mm | f₄₅₆ | 31.19 mm |
|---|---|---|---|---|---|
| Vd₁ + Vd₃ | 125.13 | (f₃ + f₄)/f | 0.59 | R₂₂/R₂₁ | −5.16 |
| f₄ + f₆ | 11.33 | TTL/BFL | 4.52 | f₁₂₃/f₄₅₆ | 0.20 |

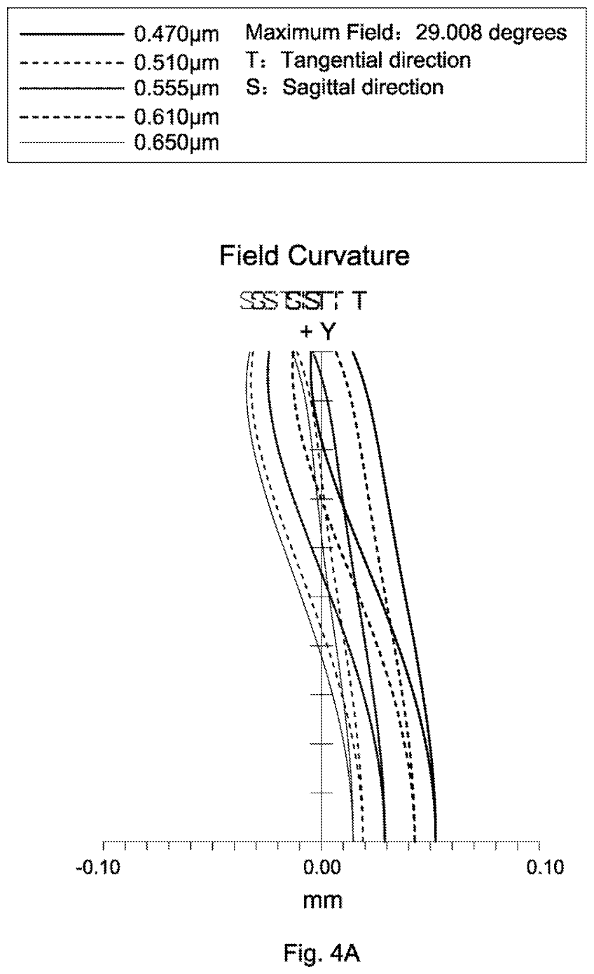

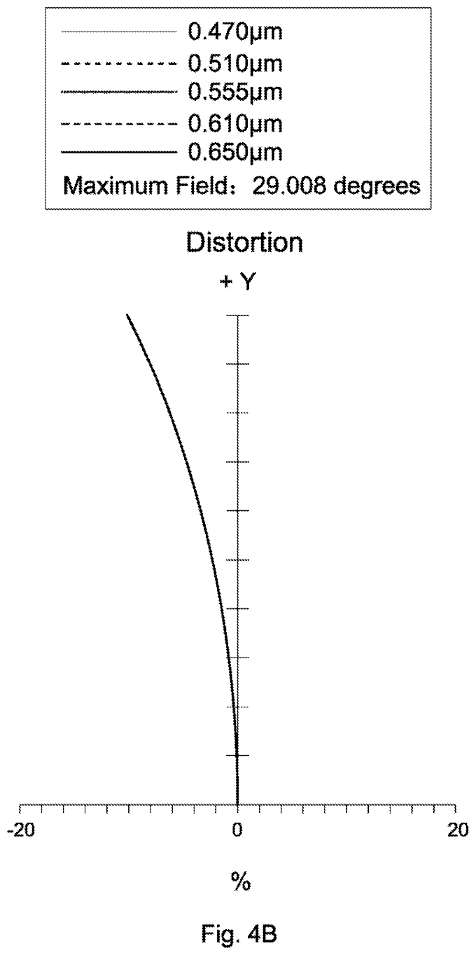

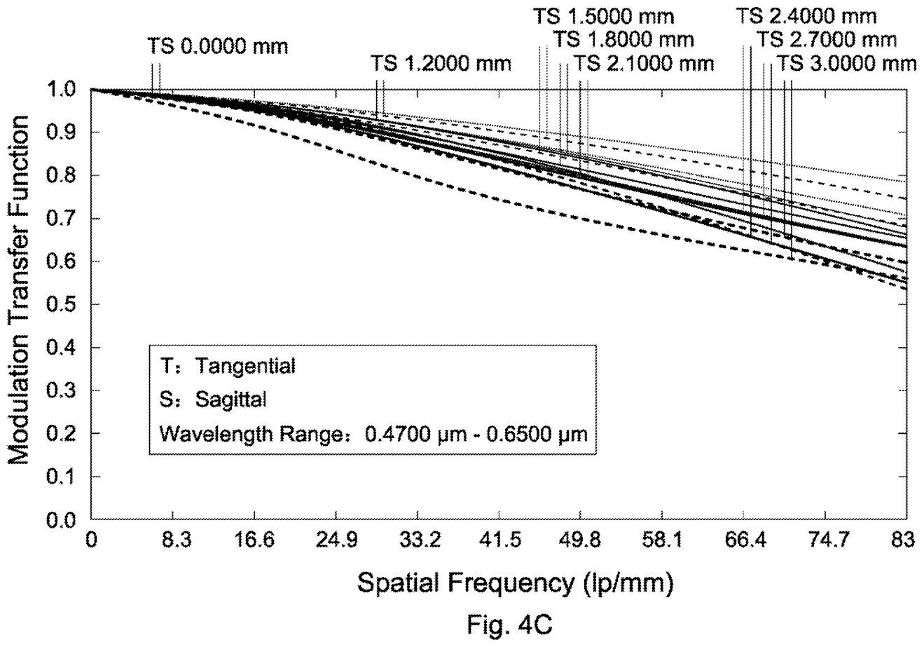

By the above arrangements of the lenses and stop ST2, the lens assembly 2 of the second embodiment can meet the requirements of optical performance as seen in FIGS. 4A-4C. It can be seen from FIG. 4A that the field curvature amount in the lens assembly 2 of the second embodiment ranges from −0.04 mm to 0.06 mm. It can be seen from FIG. 4B that the distortion in the lens assembly 2 of the second embodiment ranges from −10% to 0%. It can be seen from FIG. 4C that the modulation transfer function in the lens assembly 2 of the second embodiment ranges from 0.54 to 1.0.

It is obvious that the field curvature and the distortion of the lens assembly 2 of the second embodiment can be corrected effectively, and the resolution of the lens assembly 2 of the second embodiment can meet the requirement. Therefore, the lens assembly 2 of the second embodiment is capable of good optical performance.

Referring to FIG. 5, FIG. 5 is a lens layout and optical path diagram of a lens assembly in accordance with a third embodiment of the invention. The lens assembly 3 includes a first lens L31, a second lens L32, a third lens L33, a stop ST3, a fourth lens L34, a fifth lens L35, a sixth lens L36, an optical filter OF3, and a cover glass CG3, all of which are arranged in order from an object side to an image side along an optical axis OA3. In operation, an image of light rays from the object side is formed at an image plane IMA3.

According to paragraphs [0022]-[0031], wherein: the first lens L31 is a biconcave lens, wherein the object side surface S31 is a concave surface; the second lens L32 is a biconvex lens, wherein the image side surface S34 is a convex surface; both of the object side surface S314 and image side surface S315 of the optical filter OF3 are plane surfaces; and both of the object side surface S316 and image side surface S317 of the cover glass CG3 are plane surfaces.

With the above design of the lenses and stop ST3 and at least any one of the conditions (1)-(6) satisfied, the lens assembly 3 can have an effective decreased F-number, an effective increased resolution, an effective resisted environmental temperature change, an effective corrected aberration, and is capable of an effective corrected chromatic aberration.

Table 5 shows the optical specification of the lens assembly 3 in FIG. 5.

TABLE 5
Effective Focal Length = 6.10 mm
F-number = 1.60
Total Lens Length = 20.68 mm
Field of View = 58.02 degrees

| | Radius | | | | Effective | |
|---|---|---|---|---|---|---|
| | of Cur- | Thick- | | | Focal | |
| Surface | vature | ness | | | Length | |
| Number | (mm) | (mm) | Nd | Vd | (mm) | Remark |
| S31 | −24.91 | 0.50 | 1.54 | 74.7 | −7.82 | The First |
| | | | | | | Lens L31 |
| S32 | 5.11 | 2.96 | | | | |
| S33 | 14.80 | 1.13 | 2 | 25.46 | 12.37 | The Second |
| | | | | | | Lens L32 |
| S34 | −75.95 | 0.37 | | | | |
| S35 | 7.64 | 4.19 | 1.59 | 60.99 | 8.01 | The Third |
| | | | | | | Lens L33 |
| S36 | −10.05 | 0.15 | | | | |
| S37 | ∞ | 0.29 | | | | Stop ST3 |
| S38 | −8.81 | 1.51 | 1.96 | 17.47 | −4.46 | The Fourth |
| | | | | | | Lens L34 |
| S39 | 9.19 | 0.59 | | | | |
| S310 | −103.46 | 0.99 | 2 | 29.14 | 7.5 | The Fifth |
| | | | | | | Lens L35 |
| S311 | −7.07 | 0.25 | | | | |
| S312 | 6.46 | 3.07 | 1.77 | 49.6 | 15.8 | The Sixth |
| | | | | | | Lens L36 |
| S313 | 10.82 | 0.48 | | | | |
| S314 | ∞ | 0.21 | | | | Optical |
| | | | | | | Filter OF3 |
| S315 | ∞ | 3.00 | 1.52 | 54.52 | | |
| S316 | ∞ | 0.40 | | | | Cover |
| | | | | | | Glass CG3 |
| S317 | ∞ | 0.61 | 1.52 | 54.52 | | |

Table 6 shows the parameters and condition values for conditions (1)-(6) in accordance with the third embodiment of the invention. It can be seen from Table 6 that the lens assembly 3 of the third embodiment satisfies the conditions (1)-(6).

TABLE 6

| BFL | 4.71 mm | f₁₂₃ | 6.12 mm | f₄₅₆ | 30.16 mm |
|---|---|---|---|---|---|
| Vd₁ + Vd₃ | 135.69 | (f₃ + f₄)/f | 0.58 | R₂₂/R₂₁ | −5.13 |
| f₄ + f₆ | 11.34 | TTL/BFL | 4.39 | f₁₂₃/f₄₅₆ | 0.20 |

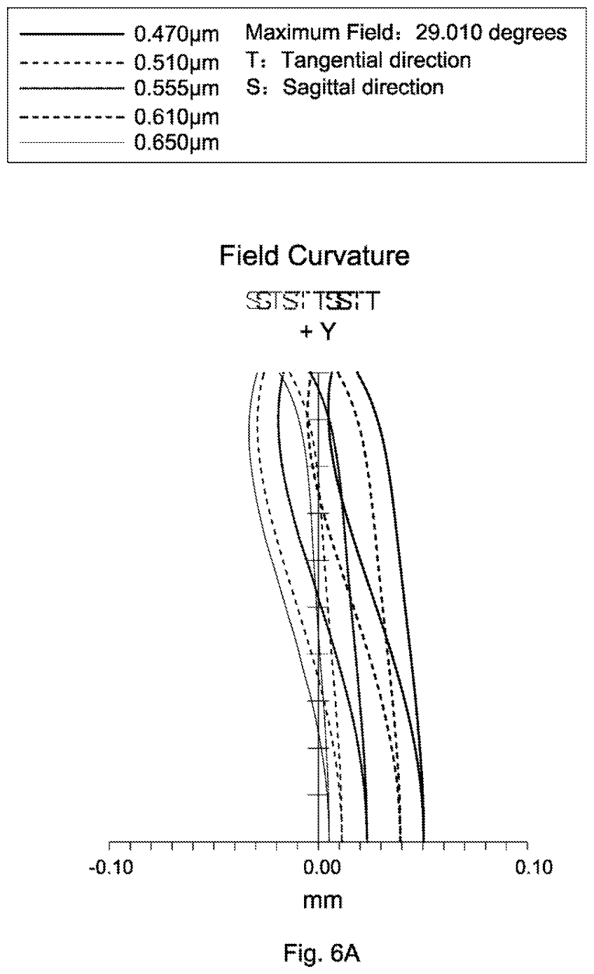

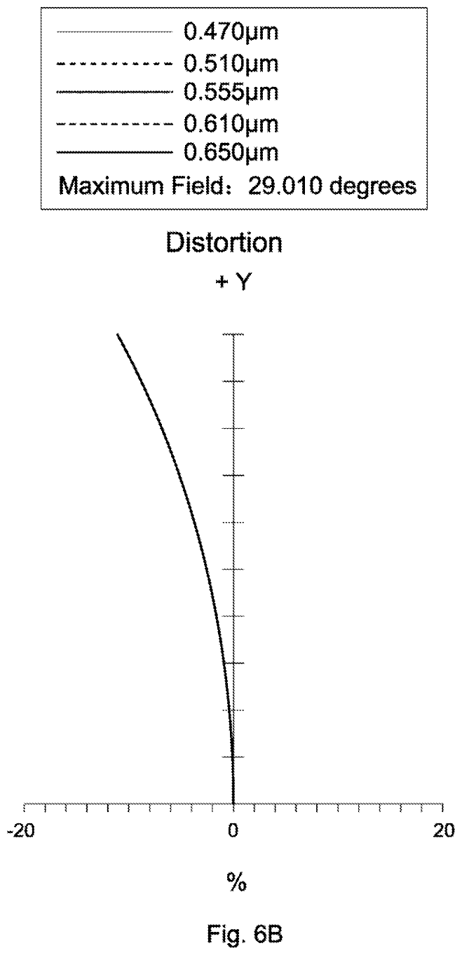

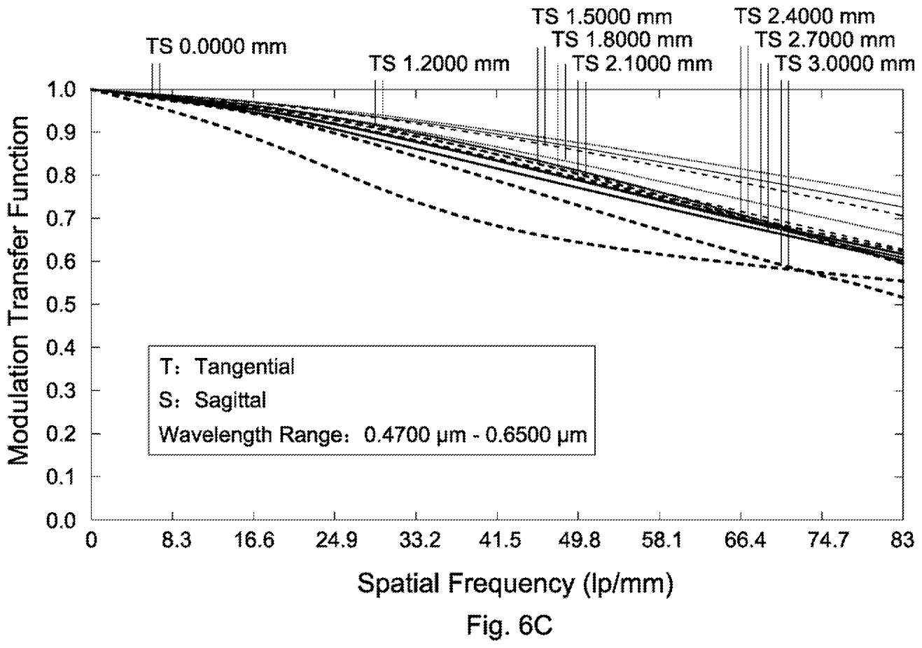

By the above arrangements of the lenses and stop ST3, the lens assembly 3 of the third embodiment can meet the requirements of optical performance as seen in FIGS. 6A-6C. It can be seen from FIG. 6A that the field curvature amount in the lens assembly 3 of the third embodiment ranges from −0.04 mm to 0.05 mm. It can be seen from FIG. 6B that the distortion in the lens assembly 3 of the third embodiment ranges from −12% to 0%. It can be seen from FIG. 6C that the modulation transfer function in the lens assembly 3 of the third embodiment ranges from 0.52 to 1.0.

It is obvious that the field curvature and the distortion of the lens assembly 3 of the third embodiment can be corrected effectively, and the resolution of the lens assembly 3 of the third embodiment can meet the requirement. Therefore, the lens assembly 3 of the third embodiment is capable of good optical performance.

Referring to FIG. 7, FIG. 7 is a lens layout and optical path diagram of a lens assembly in accordance with a fourth embodiment of the invention. The lens assembly 4 includes a first lens L41, a second lens L42, a third lens L43, a stop ST4, a fourth lens L44, a fifth lens L45, a sixth lens L46, an optical filter OF4, and a cover glass CG4, all of which are arranged in order from an object side to an image side along an optical axis OA4. In operation, an image of light rays from the object side is formed at an image plane IMA4.

According to paragraphs [0022]-[0031], wherein: the first lens L41 is a meniscus lens, wherein the object side surface S41 is a convex surface; the second lens L42 is a meniscus lens, wherein the image side surface S44 is a concave surface; both of the object side surface S414 and image side surface S415 of the optical filter OF4 are plane surfaces; and both of the object side surface S416 and image side surface S417 of the cover glass CG4 are plane surfaces.

With the above design of the lenses and stop ST4 and at least any one of the conditions (1)-(6) satisfied, the lens assembly 4 can have an effective decreased F-number, an effective increased resolution, an effective resisted environmental temperature change, an effective corrected aberration, and is capable of an effective corrected chromatic aberration.

Table 7 shows the optical specification of the lens assembly 4 in FIG. 7.

TABLE 7
Effective Focal Length = 9.59 mm
F-number = 1.64
Total Lens Length = 21.05 mm
Field of View = 35.40 degrees

| | Radius | | | | Effective | |
|---|---|---|---|---|---|---|
| | of Cur- | Thick- | | | Focal | |
| Surface | vature | ness | | | Length | |
| Number | (mm) | (mm) | Nd | Vd | (mm) | Remark |
| S41 | 50.00 | 0.500 | 1.51633 | 64.142 | −14.113 | The First |
| | | | | | | Lens L41 |
| S42 | 6.35 | 2.369 | | | | |
| S43 | 11.60 | 1.803 | 1.95375 | 32.3188 | 12.329 | The Second |
| | | | | | | Lens L42 |
| S44 | 553.14 | 0.100 | | | | |
| S45 | 6.57 | 3.936 | 1.603 | 65.4436 | 9.562 | The Third |
| | | | | | | Lens L43 |
| S46 | −37.37 | −0.057 | | | | |
| S47 | ∞ | 0.684 | | | | Stop ST4 |
| S48 | −40.95 | 0.500 | 1.95906 | 17.4713 | −4.904 | The Fourth |
| | | | | | | Lens L44 |
| S49 | 5.41 | 1.495 | | | | |
| S410 | −9.40 | 0.944 | 2.00069 | 25.4584 | 18.774 | The Fifth |
| | | | | | | Lens L45 |
| S411 | −6.60 | 0.100 | | | | |
| S412 | 7.86 | 3.363 | 1.883 | 40.7651 | 11.118 | The Sixth |
| | | | | | | Lens L46 |
| S413 | 30.96 | 0.200 | | | | |
| S414 | ∞ | 0.400 | | | | Optical |
| | | | | | | Filter OF4 |
| S415 | ∞ | 4.270 | 1.52 | 54.52 | | |
| S416 | ∞ | 0.400 | | | | Cover |
| | | | | | | Glass CG4 |
| S417 | ∞ | 0.045 | 1.52 | 54.52 | | |

Table 8 shows the parameters and condition values for conditions (1)-(6) in accordance with the fourth embodiment of the invention. It can be seen from Table 8 that the lens assembly 4 of the fourth embodiment satisfies the conditions (1)-(6).

TABLE 8

| BFL | 5.32 mm | f₁₂₃ | 7.06 mm | f₄₅₆ | 124.82 mm |
|---|---|---|---|---|---|
| Vd₁ + Vd₃ | 129.59 | (f₃ + f₄)/f | 0.49 | R₂₂/R₂₁ | 47.70 |
| f₄ + f₆ | 6.21 | TTL/BFL | 3.95 | f₁₂₃/f₄₅₆ | 0.06 |

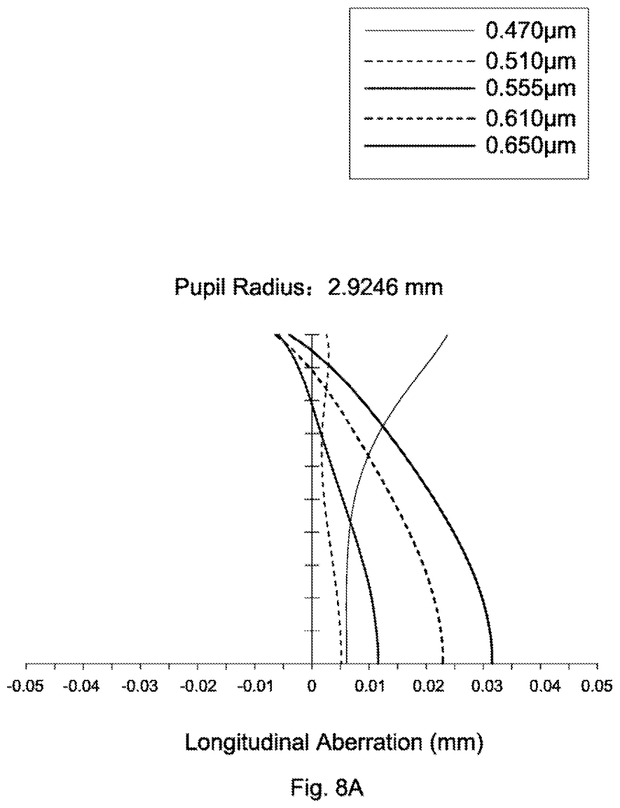

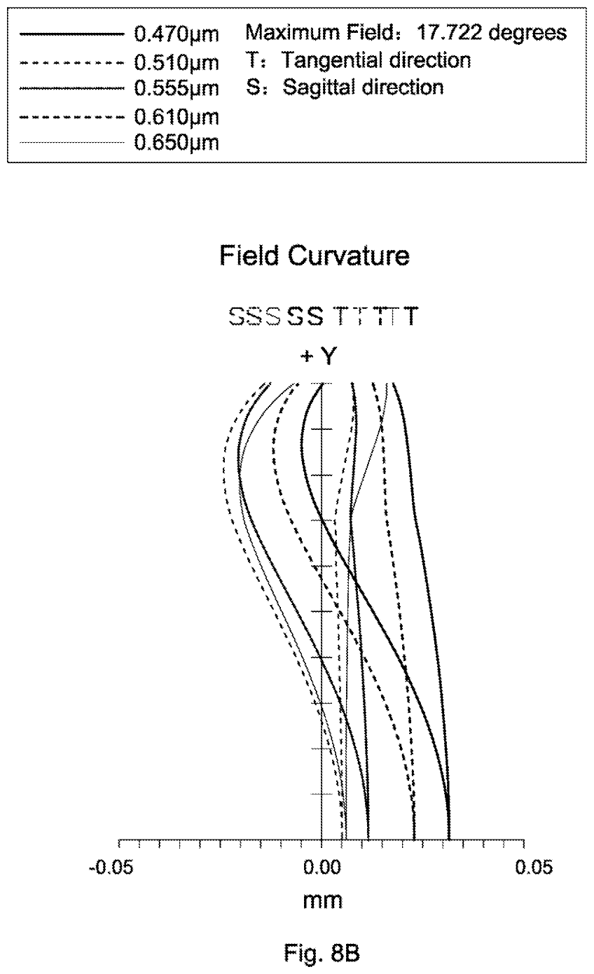

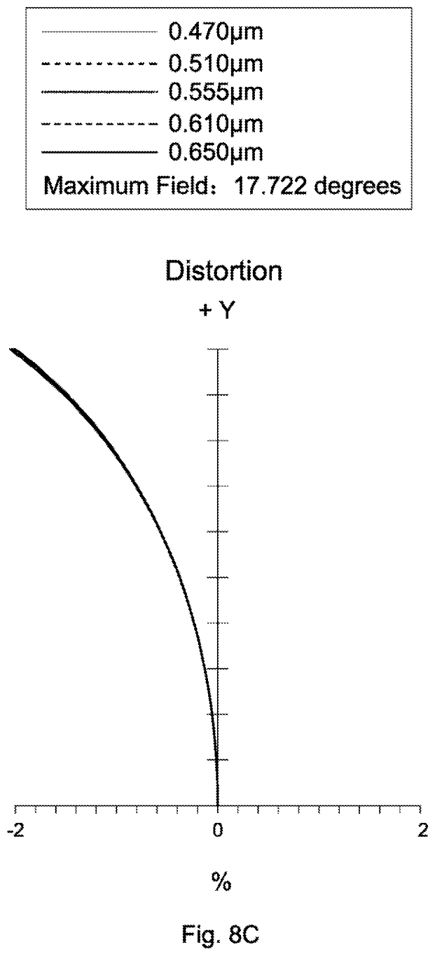

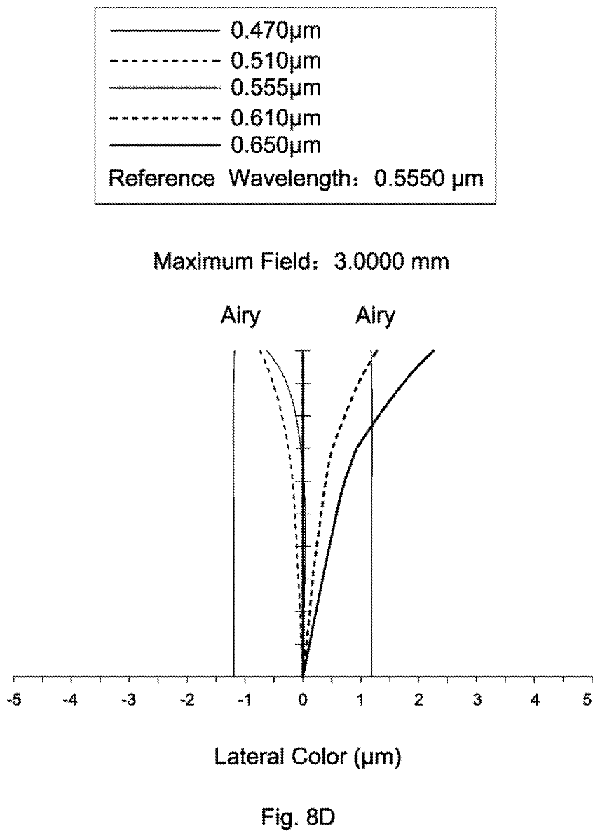

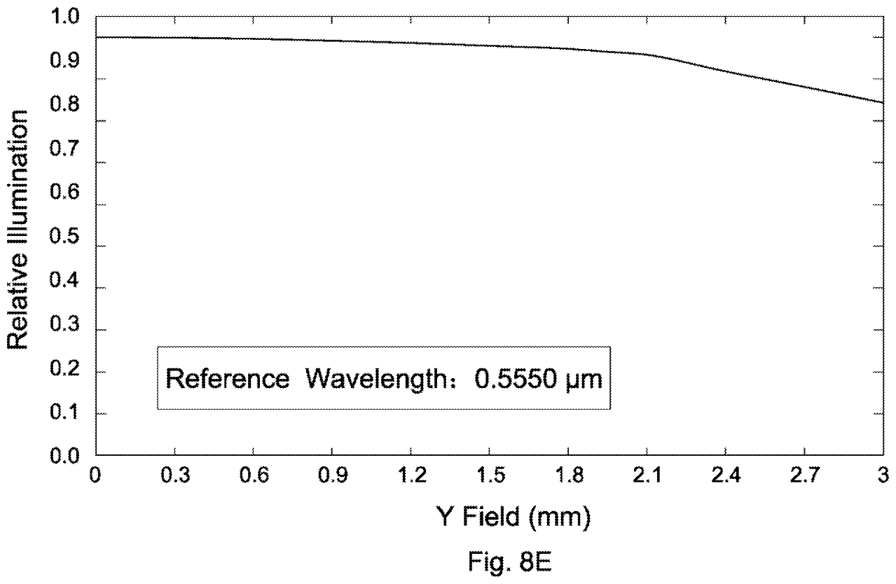

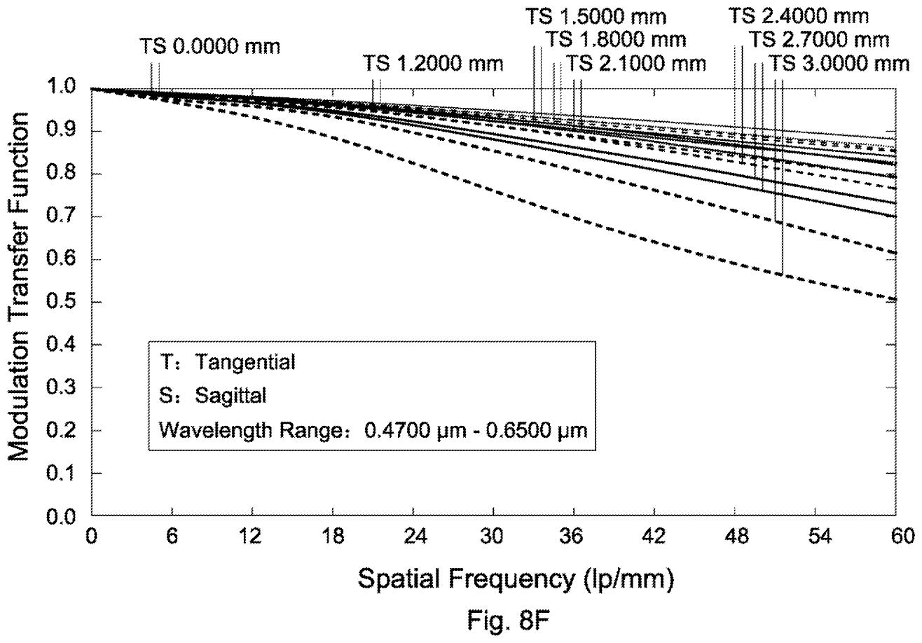

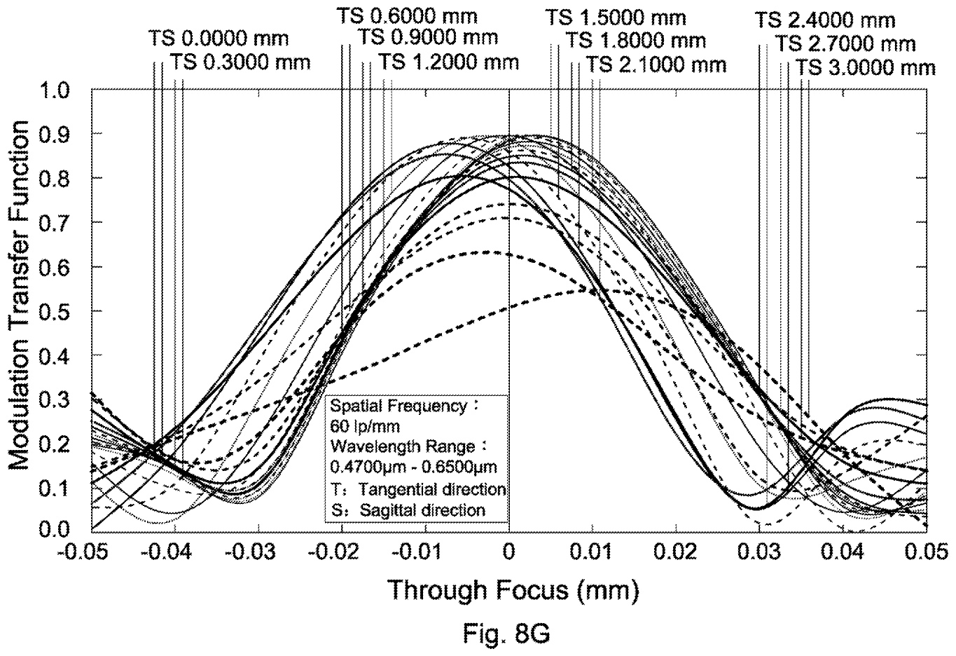

By the above arrangements of the lenses and stop ST4, the lens assembly 4 of the fourth embodiment can meet the requirements of optical performance as seen in FIGS. 8A-8G. It can be seen from FIG. 8A that the longitudinal aberration amount in the lens assembly 4 of the fourth embodiment ranges from −0.01 mm to 0.035 mm It can be seen from FIG. 8B that the field curvature amount in the lens assembly 4 of the fourth embodiment ranges from −0.025 mm to 0.035 mm. It can be seen from FIG. 8C that the distortion in the lens assembly 4 of the fourth embodiment ranges from −2% to 0%. It can be seen from FIG. 8D that the lateral color in the lens assembly 4 of the fourth embodiment ranges from −1.0 μm to 2.5 μm. It can be seen from FIG. 8E that the relative illumination in the lens assembly 4 of the fourth embodiment ranges from 0.85 to 1.0. It can be seen from FIG. 8F that the modulation transfer function in the lens assembly 4 of the fourth embodiment ranges from 0.51 to 1.0. It can be seen from FIG. 8G that the through focus modulation transfer function of tangential direction and sagittal direction in the lens assembly 4 of the fourth embodiment ranges from 0.0 to 0.90 as focus shift ranges from −0.05 mm to 0.05 mm.

It is obvious that the longitudinal aberration, the field curvature, the distortion and the lateral color of the lens assembly 4 of the fourth embodiment can be corrected effectively, and the relative illumination, the resolution and the depth of focus of the lens assembly 4 of the fourth embodiment can meet the requirement. Therefore, the lens assembly 4 of the fourth embodiment is capable of good optical performance.

It should be understood that although the present disclosure has been described with reference to the above preferred embodiments, these embodiments are not intended to retrain the present disclosure. It will be apparent to one of ordinary skill in the art that various changes or modifications to the described embodiments can be made without departing from the spirit of the present disclosure. Accordingly, the scope of the present disclosure is defined by the attached claims.

What is claimed is:

1. A lens assembly comprising:
a first lens with negative refractive power, which includes a concave surface facing an image side;
a second lens with positive refractive power, which includes a convex surface facing an object side;
a third lens with positive refractive power;
a fourth lens with negative refractive power;
a fifth lens which is a meniscus lens with positive refractive power; and
a sixth lens with positive refractive power, which includes a concave surface facing the image side;
wherein the first lens, the second lens, the third lens, the fourth lens, the fifth lens, and the sixth lens are arranged in order from the object side to the image side along an optical axis;
wherein an air gap is between the third lens and the fourth lens.

2. The lens assembly as claimed in claim 1, wherein:
the third lens comprises a convex surface facing the object side and a convex surface facing the image side; and
the fourth lens comprises a concave surface facing the object side and a concave surface facing the image side.

3. The lens assembly as claimed in claim 2, wherein further comprising a stop disposed between the third lens and the fourth lens.

4. The lens assembly as claimed in claim 3, wherein the first lens, the second lens or the third lens comprises at least one spherical glass lens.

5. The lens assembly as claimed in claim 4, wherein the lens assembly satisfies the following condition:
120<Vd₁+Vd₃<140;
wherein Vd₁ is an Abbe number of the first lens and Vd₃ is an Abbe number of the third lens.

6. The lens assembly as claimed in claim 2, wherein:
the first lens further comprises a concave surface facing the object side; and
the second lens further comprises a convex surface facing the image side.

7. The lens assembly as claimed in claim 6, wherein the lens assembly satisfies the following condition:
−7<R₂₂/R₂₁<48;
wherein R₂₁ is the radius of curvature of the object side surface of the first lens and R₂₂ is the radius of curvature of the image side surface of the second lens.

8. The lens assembly as claimed in claim 1, wherein:
the fifth lens comprises a concave surface facing the object side and a convex surface facing the image side; and
the sixth lens further comprises a convex surface facing the object side.

9. The lens assembly as claimed in claim 8, wherein:
the first lens further comprises a convex surface facing the object side; and
the second lens further comprises a concave surface facing the image side.

10. The lens assembly as claimed in claim 9, wherein the fourth lens, the fifth lens or the sixth lens comprises at least one spherical glass lens.

11. The lens assembly as claimed in claim 8, wherein the lens assembly satisfies the following condition:
3.9<TTL/BFL<6
wherein TTL is an interval from an object side surface of the first lens to the image plane along the optical axis and BFL is an interval from an image side surface of the sixth lens to an image plane along the optical axis.

12. The lens assembly as claimed in claim 8, wherein the lens assembly satisfies the following condition:
0.4<(f₃+f₄)/f<0.62;
wherein f₃ is an effective focal length of the third lens, f₄ is an effective focal length of the fourth lens, and f is the effective focal length of the lens assembly.

13. The lens assembly as claimed in claim 8, wherein the lens assembly satisfies the following condition:
6 mm<f₄+f₆<12 mm;
wherein f₄ is an effective focal length in mm of the fourth lens and f₆ is an effective focal length in mm of the sixth lens.

14. The lens assembly as claimed in claim 8, wherein the lens assembly satisfies the following condition:
0.05<f₁₂₃/f₄₅₆<0.22;
wherein f₁₂₃ is an effective focal length of a combination of the first lens, the second lens and the third lens, and f₄₅₆ is an effective focal length of a combination of the fourth lens, the fifth lens and the sixth lens.

15. A lens assembly comprising:
a first lens with negative refractive power, which includes a concave surface facing an image side;
a second lens with positive refractive power, which includes a convex surface facing an object side;
a third lens with positive refractive power;
a fourth lens with negative refractive power;
a fifth lens which is a meniscus lens with positive refractive power; and
a sixth lens with positive refractive power, which includes a concave surface facing the image side;
wherein the first lens, the second lens, the third lens, the fourth lens, the fifth lens, and the sixth lens are arranged in order from the object side to the image side along an optical axis;
wherein the lens assembly satisfies the following condition:
6 mm<f₄+f₆<12 mm;
wherein f₄ is an effective focal length in mm of the fourth lens and f₆ is an effective focal length in mm of the sixth lens.

16. The lens assembly as claimed in claim 15, wherein the lens assembly satisfies the following condition:
0.4<(f₃+f₄)/f<0.62;
wherein f₃ is an effective focal length of the third lens, f₄ is an effective focal length of the fourth lens, and f is the effective focal length of the lens assembly.

17. The lens assembly as claimed in claim 15, wherein the lens assembly satisfies the following condition:
0.05<f₁₂₃/f₄₅₆<0.22;
wherein f₁₂₃ is an effective focal length of a combination of the first lens, the second lens and the third lens, and f₄₅₆ is an effective focal length of a combination of the fourth lens, the fifth lens and the sixth lens.

18. The lens assembly as claimed in claim 15, wherein the lens assembly satisfies the following condition:
120<Vd₁+Vd₃<140;
wherein Vd₁ is an Abbe number of the first lens and Vd₃ is an Abbe number of the third lens.
